(19) United States
(12) Patent Application Publication
(10) Pub. No.: US 2026/0298288 A1
(43) Pub. Date: Oct. 1, 2026

(54) Deep Groove Ball Bearing and Arc-Shaped Roller Assembly

(71) Applicant: Aktiebolaget SKF

(72) Inventors: Jianying YANG, Kunshan (CN); Chaoxun LU, Shanghai (CN); Liwei GAO, Kunshan (CN); Hongyuan AN, Shanghai (CN)

(21) Appl. No.: 19/576,255

(22) Filed: Mar. 24, 2026

(30) Foreign Application Priority Data
Mar. 31, 2025 (CN) 202510396951.3

(51) Int. Cl. F16C 19/06; F16C 33/38; F16C 33/58

(52) U.S. Cl. CPC F16C 19/06; F16C 33/38; F16C 33/58; F16C 2202/04; F16C 2202/54; F16C 2206/60; F16C 2223/14; F16C 2240/70

(57) ABSTRACT

A deep groove ball bearing includes inner and outer rings having respective inner and outer ring raceways with respective curvature radiuses Ri, Re. A plurality of balls is disposed between the inner and outer rings and have a ball diameter Dw. The ratio of diameter to curvature radius(es) are Ri/Dw≥0.53 and/or Re/Dw≥0.53. The plurality of balls includes a first ball type having a hardness HC₁ greater than a surface hardness HRᵢ of the inner ring raceway and/or a surface hardness HRₒ of the outer ring raceway. An arc-shaped roller assembly for a paper machine has an arc-shaped roller supported by the deep groove ball bearing. Optimizing the outer/inner ring raceway(s) cost-effectively solves misalignment of the inner and outer rings and sliding wear problems, resulting in the deep groove ball bearing being particularly suitable for supporting an arc-shaped roller of a paper machine.

### CROSS-REFERENCE TO RELATED APPLICATION

This application claims priority to Chinese Patent Application No. 202510396951.3, filed Mar. 31, 2025, the entirety of which is hereby incorporated by reference.

### FIELD

The present disclosure relates to a deep groove ball bearing and an arc-shaped roller assembly.

### BACKGROUND

Bearings are commonly used in various machines. For example, arc-shaped rollers (i.e. spread roller, shown as box A in FIG. 6) are often used in paper machines. Arc-shaped rollers are not common cylindrical rollers, but are roller-like members with a certain crown (or curvature), so the running stability of the bearings supporting the arc-shaped rollers are crucial to the arc-shaped rollers. A common arc-shaped roller has a length of about 10 μm and a journal of about 0.3 μm. And the arc-shaped roller is usually supported by deep groove ball bearings (hereinafter referred to as bearings). As shown in box B of FIG. 7, an arc-shaped roller may be equipped with about 20 bearings and weigh about 5.5 tons. However, the bearings for the arc-shaped roller is subjected to small and uneven loads during operation, and at the same time, due to problems such as the structural design of the inner shaft, there is a large misalignment problem of the inner/outer rings of the bearing.

Therefore, because of the special arc-shaped design, arc-shaped rollers in paper machines often require needs stable operation under large misalignment of bearings. In addition, bearings may also suffer from slipping wear under too small and uneven loads and high-speed operation. Ultimately, wear particles will cause bearing failure.

Therefore, there is a need in the art for a simple and reliable way to improve the deep groove ball bearings, in particular, to address the problems of misalignment and sliding wear of the deep groove ball bearings applied to the arc-shaped rollers of paper machines.

### SUMMARY

In response to the above-mentioned problems and needs, the present disclosure proposes a new technical solution, which solves the above problems and brings other technical effects by adopting the following technical features.

The present disclosure provides a deep groove ball bearing, comprising: an inner ring having an inner ring raceway with a curvature radius Ri of the inner ring raceway; an outer ring having an outer ring raceway with a curvature radius Re of the outer ring raceway; a plurality of balls disposed between the inner ring and the outer ring and each ball having a ball diameter Dw; wherein Ri/Dw≥0.53 and/or Re/Dw≥0.53; and one or more first type balls of the plurality of balls have a first hardness HC₁, wherein the first hardness HC₁ is greater than a surface hardness HRᵢ of the inner ring raceway and/or the first hardness HC₁ is greater than a surface hardness HRₒ of the outer ring raceway.

The present disclosure also provides an arc-shaped roller assembly for a paper machine, comprising: an arc-shaped roller; a deep groove ball bearing as previously described for supporting the arc-shaped rollers.

By optimizing the raceway of the inner/outer ring of the deep groove ball bearing according to the present disclosure, misalignment of the inner and outer rings and sliding wear problems can be solved effectively and cost-effectively, so that such designed deep groove ball bearing is particularly suitable for supporting an arc-shaped roller of a paper machines.

### BRIEF DESCRIPTION OF THE DRAWINGS

FIG. 1 shows a cross-sectional view of a deep groove ball bearing according to a preferred embodiment of the present disclosure;

FIG. 2 shows a partial front view of a deep groove ball bearing according to a preferred embodiment of the present disclosure;

FIG. 3 shows a schematic diagram of friction energy loss over time before and after optimization for the inner ring raceway;

FIG. 4 shows a schematic diagram of friction energy loss over time before and after optimization for the outer ring raceway;

FIG. 5 shows a schematic diagram of the impact force between the cage and the ball as a function of time;

Box A of FIG. 6 shows a schematic diagram of an arc-shaped roller in a paper machine;

Box B of FIG. 7 shows where the bearings for supporting the arc-shaped rollers are located.

### DETAILED DESCRIPTION

In order to make the purpose, technical solutions and advantages of the technical solutions of the present disclosure clearer, the technical solutions of the embodiments of the present disclosure will be clearly and completely described below with reference to the accompanying drawings of specific embodiments of the present disclosure. The same reference numbers in the drawings represent the same parts. It should be noted that the described embodiments are some, not all, of the embodiments of the present disclosure. Based on the described embodiments of the present disclosure, all other embodiments obtained by those skilled in the art without creative efforts fall within the scope of protection of the present disclosure.

Possible implementations within the scope of protection of the present disclosure may have fewer components than the embodiments illustrated in the figures, have other components not illustrated in the figures, different components, differently arranged components or differently connected components, etc. Furthermore, two or more components in the figures may be implemented within a single component, or a single component shown in the figures may be implemented as multiple separate components.

Unless otherwise defined, technical or scientific terms used herein shall have their ordinary meaning as understood by one of ordinary skill in the art to which this disclosure belongs. The terms “first”, “second” and similar words used in the specification and claims of this disclosure do not indicate any order, quantity or importance, but are only used to distinguish different components. When the number of components is not stated, the number of components can be one or more; likewise, words such as “a”, “the”, “said” and similar words do not necessarily indicate a quantitative limitation. Words such as “include” or “include” mean that the elements or items appearing before the word include the elements or items listed after the word and their equivalents, without excluding other elements or items. Words such as “installation”, “setting”, “connection” or “connection” are not limited to physical or mechanical installation, setting, and connection, but may include electrical installation, setting, and connection, whether direct or indirect. “Up”, “down”, “left”, “right”, etc. are only used to represent the relative orientation relationship when the device is used or the orientation relationship shown in the drawings. When the absolute position of the described object changes, the relative position Relationships may also change accordingly.

For ease of explanation, the direction of the rotational axis of the bearing is referred to herein as the axial direction, and the direction perpendicular to the axial direction is referred to as the radial direction. The term “inward” means along towards the inside of the bearing, and conversely, the term “outer” means towards the outside of the bearing.

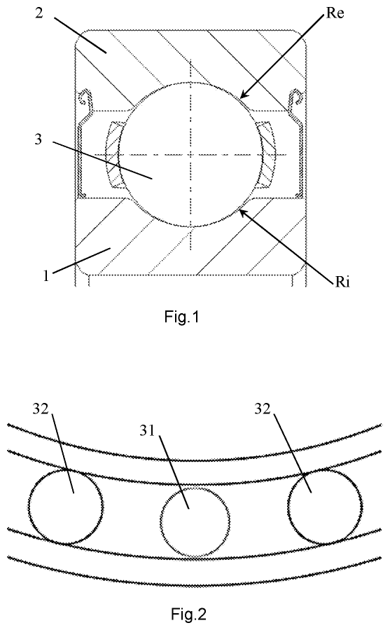

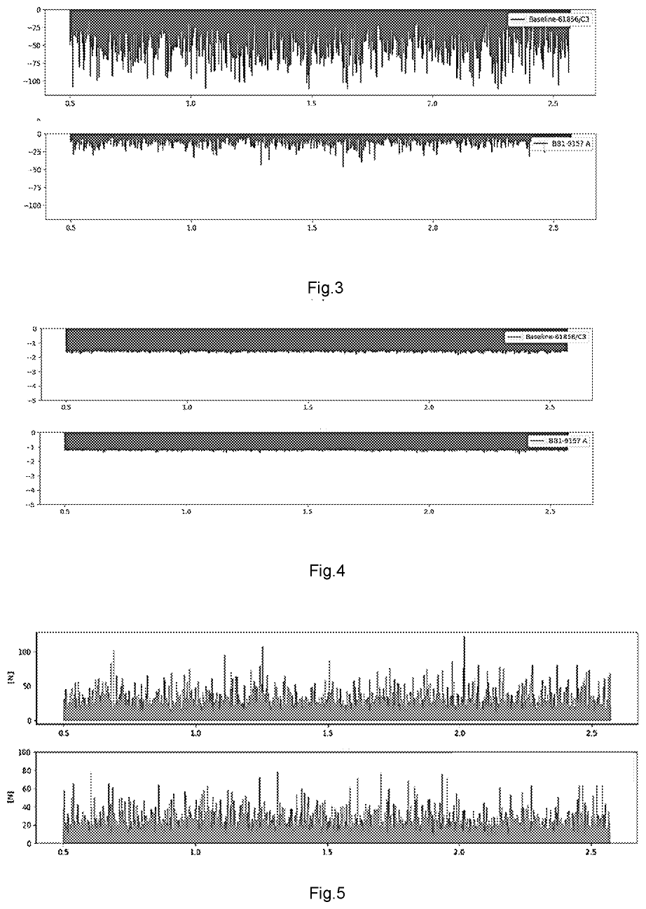

Referring now to the preferred embodiment shown in FIGS. 1-2, the present disclosure provides a deep groove ball bearing which has been variously optimized for use in supporting the components such as arc-shaped rollers of a paper machine.

The deep groove ball bearing includes: an inner ring 1 having an inner ring raceway; an outer ring 2 having an outer-ring raceway; a plurality of balls 3 disposed between the inner race 1 and the outer race 2.

According to the inventor's research, there are various factors that affect the inner/outer ring misalignment and slipping wear problems of deep groove ball bearings. In particular, the balls involve various movements such as sliding, rolling, rotation, and revolution at early stage of the operation as well as during the operation. Slipping (or sliding) will cause friction between the balls and the raceway surface, thereby causing problems such as wear and torque variation. Moreover, due to the particular shape and rotation manner of the arc-shaped rollers of the paper machine, the bearings supporting them are more prone to problems of inner/outer ring misalignment and sliding wear.

Through targeted structural design and extensive experimental research, it is found that optimizing and improving inner ring raceway and outer ring raceway of the deep groove ball bearing can solve the problem of inner/outer ring misalignment and sliding wear in a simpler, more effective and lower cost way.

Therefore, the present disclosure provides that Ri/Dw≥0.53 and/or Re/Dw≥0.53, where Ri is the curvature radius of the inner ring raceway, Re is the curvature radius of the outer ring raceway, and Dw is the ball diameter of each ball 3. Further, one or more of the first type balls 31 of the plurality of balls 3 have a first hardness HC₁, wherein the first hardness HC₁ is greater than the hardness HRᵢ of the inner ring raceway surface, and/or the first hardness HC₁ is greater than the surface hardness HRₒ of the outer ring raceway.

The problems of misalignment and sliding wear of the inner/outer rings of the bearing can be greatly improved by optimizing one or both of the raceway of the inner ring and the raceway of the outer ring, especially in the case of the deep groove ball bearing being applied to the arc-shaped rollers of the paper machines. Moreover, after applying the above optimization design to the inner ring raceway and the outer ring raceway at the same time, an effect of raceway optimization is far more superior than that when only the inner ring or the outer ring is optimized. Preferably, Ri/Dw=0.53-0.57. Preferably, Re/Dw=0.53-0.57.

Moreover, according to the research of the inventor, during the operation of the bearing, it is inevitable that the worn and peel off materials from the inner and outer rings and balls or foreign matter enters the interior of the bearing. These worn-off particles or foreign matter particles exist between the surfaces of the moving parts of the bearing, which may easily cause surface damage, such as the formation of scratches, pits, convex points, etc. When the damage is severe or when minor damage develops into severe damage, such surface damage will significantly affect the bearing stability, even cause or aggravate the bearing misalignment and the sliding wear. Especially in the case of arc-shaped rollers, unstable bearing operation due to surface damage will seriously affect the operating status of the arc-shaped rollers.

Therefore, the present disclosure proposes that the first type balls 31 of the plurality of balls 3 in the bearing have a first hardness HC₁, and that the first hardness HC₁ is greater than the surface hardness HRᵢ of the inner race raceway. Therefore, the harder balls can grind and polish the surfaces of the inner/outer ring raceway during the operation of the bearing, so that the above-mentioned surface damage (especially serious surface damage such as bumps) can be “grinded off”, so as to better maintain the curvature radius of the inner and outer ring raceways within an ideal range as mentioned above, and ensure the ability of the bearing to resist misalignment and sliding friction in real time. Moreover, this grinding action can exert a significant effect at the emergence of surface damage, preventing surface damage from spreading to cause serious problems such as bearing failure. Thus, the bearing has a wear resistance coefficient of >7 and a life coefficient of >3 as tested experimentally, that is, the entire bearing exhibits more wear resistance and longer life characteristics.

Preferably, the ratio of the first hardness HC₁ to the surface hardness HRᵢ of the inner ring raceway may be HC₁≥1.2 HRᵢ; and/or the first hardness HC₁ is greater than the surface hardness HRₒ of the outer-ring raceway, and preferably, the ratio of the first hardness HC₁ to the surface hardness HRₒ of the outer-ring raceway may be HC₁≥1.2 HRₒ.

Further preferably, the second type balls 32 of the plurality of balls 3 may have a second hardness HC₂, and the first hardness HC₁ is greater than the second hardness HC₂. More preferably, the ratio of the first hardness HC₁ to the second hardness HC₂ is HC₁≥1.5 HC₂.

Therefore, the first type balls 31 may be made of any suitable material having the first hardness, such as ceramic or silicon nitride or steel having the first hardness, such that it is greater than the surface hardness of the inner and outer ring raceway and the hardness of the second type balls. Alternatively, the first type balls 31 may be made of steel and subjected to a nitriding treatment to obtain the first hardness.

In addition, the present disclosure also proposes that the first type ball 31 may be a single ball. Alternatively, the first type balls 31 may be a plurality of balls, and the balls may be evenly distributed at equal angular distances along the circumferential direction, thereby achieving a more uniform grinding and polishing action on the raceway surfaces of the inner and outer rings.

Further testing and research have found that surprisingly superior results are achieved after optimizing the inner/outer ring raceways as described above.

FIG. 3 shows a schematic diagram of the friction energy loss as a function of time, before optimization (upper graph) and after optimization (lower graph) of the inner ring raceway, where the abscissa is time (in seconds) and the ordinate is the friction energy loss (in W/mm²). It can be seen that after the raceway is optimized, the friction energy loss on the inner ring is significantly reduced, and the reduction amount is ≥70%.

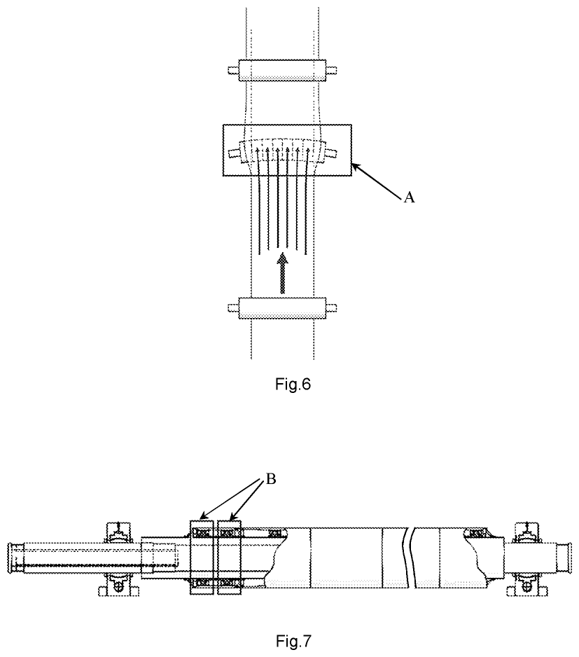

FIG. 4 shows a schematic diagram of the friction energy loss as a function of time, before optimization (upper graph) and after optimization (lower graph) of the outer ring raceway, where the abscissa is time (in seconds) and the ordinate is the friction energy loss (in W/mm²). It can be seen that after the raceway is optimized, the friction energy loss on the outer ring is significantly reduced, and the reduction amount is ≥50%.

FIG. 5 shows a schematic diagram of the impact force between the cage and the balls as a function of time, where the abscissa is time (in seconds) and the ordinate is force (in N). Before optimizing the inner and outer ring raceways (upper graph), an average impact force between the balls and both sides of the cage is above 40N, while after optimizing the inner and outer ring raceways (lower graph), an average impact force between the balls and both sides of the cage is reduced to about 20N.

Furthermore, after the above optimization of the bearing, since the axial contact area is located within the raceway area, the ability of the bearing to withstand inner/outer misalignment is greatly improved, so that the risk of the balls climbing over the shoulder of the bearing is reduced to zero.

According to the inventor's research, the friction coefficient of the raceway surface of the bearing inner/outer rings and the friction coefficient of the ball surface also has a great influence on the slipping. Therefore, the present disclosure proposes that the inner ring raceway surface, the outer ring raceway surface and/or the surfaces of the plurality of balls 3 are coated. Preferably, the coating may be a coating obtained by blackening treatment, or the coating may be a molybdenum disulfide coating. Further preferably, the coating thickness is 0.3-5 μm.

By applying a coating to optimize the coefficient of friction, the probability of occurrence of slipping can be significantly reduced, and even if slipping occurs, the frictional force generated is significantly reduced. In addition, setting the coating thickness within the above optimized range can also further increase the coating life.

Further preferably, the bearing adopts a non-contact metal dust cover.

Furthermore, the internal free space between the inner and outer rings of the bearing and the non-contact metal dust cover is filled with anti-slip grease, and the viscosity of the anti-slip grease is 20-40 mm²/s at 40° C., thereby ensuring that the bearing can operate without maintenance for a long time.

In addition, the bearings can use a standard steel stamped cage.

Further, the present disclosure provides an arc-shaped roller assembly for a paper machine, comprising: an arc-shaped roller; and a deep groove ball bearing as previously described for supporting said arc-shaped roller. Thus, after applying the deep groove ball bearing according to the present disclosure, the arc-shaped roller assembly of the paper machine can run more smoothly and the life of the entire assembly is longer.

The exemplary embodiments of the present disclosure have been described in detail above with reference to preferred embodiments. However, those skilled in the art will understand that various modifications and modifications can be made to the above specific embodiments without departing from the concept of the present disclosure. Modifications, and various technical features and structures proposed in the present disclosure can be made in various combinations without exceeding the scope of protection of the present disclosure, which is determined by the appended claims.

What is claimed is:

1. A deep groove ball bearing comprising:
an inner ring having an inner ring raceway with a curvature radius (Ri) of the inner ring raceway;
an outer ring having an outer ring raceway with a curvature radius (Re) of the outer ring raceway; and
a plurality of balls disposed between the inner ring and the outer ring, each ball having a ball diameter (Dw), the plurality of balls including one or more first type balls having a first hardness (HC₁), the first hardness (HC₁) being greater than a surface hardness (HRᵢ) of the inner ring raceway and/or a surface hardness (HRₒ) of the outer ring raceway;
wherein Ri/Dw≥0.53 and/or Re/Dw≥0.53.

2. The deep groove ball bearing according to claim 1, wherein Ri/Dw=0.53-0.57 and Re/Dw=0.53-0.57.

3. The deep groove ball bearing according to claim 1, wherein a ratio of the first hardness (HC₁) to the surface hardness (HRᵢ) of the inner ring raceway is HC₁≥1.2 HRᵢ and/or a ratio of the first hardness (HC₁) to the surface hardness (HRₒ) of the outer ring raceway is HC₁≥1.2 HRₒ.

4. The deep groove ball bearing according to claim 3, wherein the ratio of the first hardness (HC₁) to the surface hardness (HRᵢ) of the inner ring raceway is HC₁≥1.2 HRᵢ and the ratio of the first hardness (HC₁) to the surface hardness (HRₒ) of the outer ring raceway is HC₁≥1.2 HRₒ.

5. The deep groove ball bearing according to claim 3, wherein the plurality of balls includes one or more second type balls having a second hardness (HC₂), the first hardness (HC₁) being greater than the second hardness (HC₂).

6. The deep groove ball bearing according to claim 5, wherein a ratio of the first hardness (HC₁) to the second hardness (HC₂) is HC₁≥1.5 HC₂.

7. The deep groove ball bearing according to claim 3, wherein:
the one or more first type balls are made of ceramic or silicon nitride or steel having the first hardness, or
the one or more first type balls are made of a steel subjected to a nitriding treatment to obtain the first hardness.

8. The deep groove ball bearing according to claim 3, wherein the one or more first type balls includes a plurality of first type balls, the plurality of first type balls being evenly distributed at equal angular distances along the circumferential direction.

9. The deep groove ball bearing according to claim 1, wherein the inner ring raceway surface, the outer ring raceway surface and/or the surfaces of the plurality of balls are coated with a coating, the thickness of the coating being 0.3-5 μm.

10. The deep groove ball bearing according to claim 9, wherein the coating comprises a coating obtained by blackening treatment or a molybdenum disulfide coating.

11. The deep groove ball bearing according to claim 1, further comprising a non-contact metal dust cover.

12. The deep groove ball bearing according to claim 11, further comprising an anti-slip grease filling an internal free space between the inner ring, the outer ring and the non-contact metal dust cover, the viscosity of the anti-slip grease being 20-40 mm²/s at 40° C.

13. The deep groove ball bearing according to claim 1, further comprising a steel stamped cage.

14. The deep groove ball bearing according to claim 13, wherein the ratio of the first hardness (HC₁) to the surface hardness (HRᵢ) of the inner ring raceway is HC₁≥1.2 HRᵢ and the ratio of the first hardness (HC₁) to the surface hardness (HRₒ) of the outer ring raceway is HC₁≥1.2 HRₒ.

15. The deep groove ball bearing according to claim 14, wherein the plurality of balls includes one or more second type balls having a second hardness (HC₂), the first hardness (HC₁) being greater than the second hardness (HC₂).

16. The deep groove ball bearing according to claim 15, wherein a ratio of the first hardness (HC₁) to the second hardness (HC₂) is HC₁≥1.5 HC₂.

17. The deep groove ball bearing according to claim 16, wherein:
the one or more first type balls are made of ceramic or silicon nitride or steel having the first hardness, or
the one or more first type balls are made of a steel subjected to a nitriding treatment to obtain the first hardness.

18. The deep groove ball bearing according to claim 17, wherein the one or more first type balls includes a plurality of first type balls, the plurality of first type balls being evenly distributed at equal angular distances along the circumferential direction.

19. The deep groove ball bearing according to claim 15, wherein the inner ring raceway surface, the outer ring raceway surface and/or the surfaces of the plurality of balls are coated with a coating, the thickness of the coating being 0.3-5 μm.

20. The deep groove ball bearing according to claim 19, wherein the coating comprises a coating obtained by blackening treatment or a molybdenum disulfide coating.

21. The deep groove ball bearing according to claim 18, further comprising a non-contact metal dust cover.

22. The deep groove ball bearing according to claim 21, further comprising an anti-slip grease filling an internal free space between the inner ring, the outer ring and the non-contact metal dust cover, the viscosity of the anti-slip grease being 20-40 mm²/s at 40° C.

23. The deep groove ball bearing according to claim 22, further comprising a steel stamped cage.

24. An arc-shaped roller assembly for a paper machine, the arc-shaped roller assembly comprising:
an arc-shaped roller; and
the deep groove ball bearing according to claim 23, the deep groove ball bearing supporting the arc-shaped roller.

25. An arc-shaped roller assembly for a paper machine, the arc-shaped roller assembly comprising:
an arc-shaped roller; and
the deep groove ball bearing according to claim 1, the deep groove ball bearing supporting the arc-shaped roller.
